(19) United States
(12) Patent Application Publication
(10) Pub. No.: US 2006/0167930 A1
(43) Pub. Date: Jul. 27, 2006

(54) SELF-ORGANIZED CONCEPT SEARCH AND DATA STORAGE METHOD

(76) Inventors: George Witwer, Bluffton, IN (US); Ravi Kumar Kondadadi, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/275,554

(22) Filed: Jan. 13, 2006

Related U.S. Application Data
(63) Continuation-in-part of application No. 10/961,314, filed on Oct. 8, 2004.
(60) Provisional application No. 60/697,657, filed on Jul. 8, 2005.

(51) Int. Cl. G06F 17/00; G06F 7/00

(52) U.S. Cl. 707/102

(57) ABSTRACT

A document search and retrieval system and method stores documents in groups based on content. The documents are self-organized into a hierarchy of conceptual clusters, and branches of the hierarchy are stored separately in distinct physical stores, each having an index. In response to a query, the system finds the concepts (clusters) that best match the search criteria and returns the documents from those content categories. The indexing, clustering, and searching are performed using document themes and/or summaries. Themes are automatically developed by stemming and scoring phrases from the sentences in each document, and clustering the sentences containing the highest-scoring stems. A set of phrases (themes) is taken from each cluster. Document summaries are taken from text segments for each cluster of sentences within a document, then strung together to create a summary.

### REFERENCE TO RELATED APPLICATIONS

The present application claims priority to U.S. Provisional Patent Application No. 60/697,657 (“SELF-ORGANIZED CONCEPT SEARCH AND DATA STORAGE METHOD”), and also as a continuation-in-part to U.S. patent application Ser. No. 10/961,314 (“CLUSTERING BASED PERSONALIZED WEB EXPERIENCE”).

### FIELD OF THE INVENTION

The present invention relates to systems and methods for storing and searching for electronic documents. More specifically, the present invention relates to systems and methods for generating themes and summaries for electronic documents, storing and retrieving the documents using clustering techniques for both storage and retrieval.

### BACKGROUND

The invention relates generally to a system and method for automatically processing text to extract concepts for presentation to users, storing the text and/or related information, and efficiently retrieving documents relative to a concept.

In existing storage, search, and retrieval art, electronic documents are often stored in conceptually monolithic databases. Even when the database is distributed, documents that are related to similar concepts are stored throughout the database. As the database grows, the search complexity also grows in O(n).

Automatic text storage and retrieval systems sometimes automatically decompose into segments and themes in an attempt to present a user with material that is as relevant as possible to the user's query. Some of these systems compare individual sentences with other sentences to determine their similarity in terms of words that are used in both (or sometimes synonyms or related words derived from “word chains,” and “or families”) to link multiple sentences together in coherent text units. The systems, however, sometimes fail to capture all related sentences, paragraphs, and passages that relate to minor themes or sporadically presented themes of a document.

There is thus a need for further contributions and improvements to technology relating to storing, retrieving, theming, and summarizing of electronic documents.

### SUMMARY

It is an object of the present invention to provide an improved system and method for storing, retrieving, theming and/or summarizing electronic documents. It is another object of the present invention to provide an improved system and method for storing and retrieving electronic documents, especially text-based documents.

These objects and others are achieved by various forms of the present invention. One form of the present invention is a system for indexing and retrieving information regarding the plurality of documents. A plurality of data stores each has an index and a search engine for finding documents in the data store that meet one or more pre-determined criteria. A plurality of document concepts are each associated with at least one of the data stores. For each of the plurality of documents, a clustering engine associates the document with one or more of the concepts and adds information about the document to the index of each data store with which the one or more concepts is associated. A clustering engine also updates organization of the concepts according to one or more predetermined criteria.

In variations of this form, when a concept meets some particular criterion, the clustering engine splits the concept into 2 or more concepts, each in its own physical data store.

In other variations, the system is searched by checking the indices for the best-matching concepts, then retrieving further information about the documents in the matching concepts from the data store(s) that contain those concepts.

In different variations of this form, the data stores are part of the same or different computers, and may be connected to the clustering engine via an electronic data network.

In still other variations of this form, the search criteria are key words to be matched in the index for the various concepts, while in others, the “one or more search criteria” includes an analysis of similarity to material in a query (such as a document or search terms).

Another form of the invention is a method for self-organizing and storing a plurality of electronic documents that includes clustering the documents so that each is in at least one conceptual cluster out of many that form a hierarchy, including a first and a second cluster. For each cluster, all documents in the cluster are stored in one physical storage partition, which might be stored in one or more storage devices. All documents in the first cluster are stored in one storage partition, all documents in the second cluster are stored in a different storage partition, and there is no document that is in the second cluster, is stored in the first partition, and is not in the first cluster.

In various embodiments, documents can be in more than one cluster, while in other embodiments, documents may only be in a single cluster. The clusters are preferably organized in a hierarchy, but in some embodiments they are strictly disjoint.

In one variation of this form, when a document is added to the repository, the system determines which one or more clusters the document belongs in, and the document is added to each. The system then determines whether to split each of those clusters into two or more clusters based, for example, on the remaining storage capacity of the physical store(s) that hold(s) the cluster, timing, processor and/or storage device load, a maximum number of clusters allowed, and a metric of similarity among documents in the cluster. If division of the cluster into multiple clusters is determined to be appropriate, the system adjusts the hierarchy of clusters accordingly, separating the old cluster into two or more and fitting them within the hierarchy as appropriate. The related documents are moved to separate physical stores as desired or required.

Another form of this invention is for searching electronic documents by receiving a query signal, that includes one or more search terms, then responsively searching a plurality of concept indices, each providing an index to a plurality of electronic documents that relate to a common concept. This searching includes quantifying the relationship between one or more search terms and each of the concept indexes as a similarity value, and selecting the concept indexes having a similarity value that indicates a relationship closer than a threshold. The system then retrieves references to each of the electronic documents in each of the selected concept indexes.

In certain variations of this form, the “retrieving” step involves querying the database with document identifiers for the documents in the corresponding concept indexes, and receiving the documents in response. In other variations, the similarity threshold is a calculated average of a group of similarity values. In others, it is a fixed number, or the greater or lesser of the n^{th} largest or smallest value when compared with a fixed similarity threshold.

Another form of the invention is a 3-layer architecture for self-organized concept searching. A search string layer receives a search query, and one or more physical data stores hold documents or data about documents. A concept index layer includes a plurality of indexes, each index being associated with one of the physical data stores, and each index containing data that relates to a plurality of the electronic documents. The system quantifies the closeness of the conceptual relationship between each of the indexes and the search query, then based on the quantification, identifies one or more indexes that best match the search query. The system identifies the documents indexed by the one or more identified indexes and provides a result signal as a function of the identified documents. In some implementations of this form, the result responsive to the query is a list of references to the identified documents, perhaps sorted by similarity to the search query. In other embodiments, the result is a list of document themes or summaries for the identified documents.

In other variations, one can add documents to the set of physical data stores, whereby the documents are indexed into the best matching index(es) and stored in the associated physical data store.

Another form of the present invention is a system for generating a list of one or more themes from an electronic document. Computer software identifies sentences in the document, parses the sentences into tokens, and lists all phrases in the document having no more than a predetermined number of tokens. This system counts the frequency of these phrases, stems the phrases to a predetermined length (such as a predetermined number of characters), and scores the stems as a function of length and frequency. The system then clusters the sentences based on the similarly of the stems they contain, and builds a set of phrases (“themes”) out of phrases from those sentences that were grouped into a cluster with at least one other sentence.

In variations of this form, the tokens are words, and in others, the counting may take place simultaneously with the listing functions, or at least during the same pass through the document. In some embodiments, the stemming is done before the counting, while in others, the stemming is done after the counting. The scoring function may also take into account the position of each appearance of the stem within the paragraph and/or the document.

Some embodiments determine the part of speech of each token, then filter the tokens based on their part of speech as they are used. Further, some embodiments filter out stop words or tokens. In both types of embodiments, the words or tokens that remain after the filtering are processed by the counting, stemming, and scoring steps or functions. Stems, as used in these embodiments, are sub-strings of phrases having no more than a predetermined number of characters.

Yet another form of the invention is a system for generating a summary of an electronic document. The system identifies coherent segments of text in the document, each sentence from the document being part of at least one coherent segment. The system clusters the sentences from the document based on their content, using some metric of similarity that preferably reflects the similarity of meaning between the sentences. The system generates a passage for each cluster of sentences by sorting the sentences based on their position in the original document, selecting a number of sentences from the beginning of the sorted list, and for each of those sentences, adding to the passage the smallest coherent segment of which the sentence is a part.

In variations of this form, sentences are clustered using themes generated, for example, by the theme-generation method described just above. In some embodiments, the generated passages are presented to a human user as paragraphs, either individually or taken together to summarize the document.

In still other embodiments, the “minimum number of sentences” taken from the beginning of the sorted list of sentences is two, so that at least two sentences are always provided in each passage.

Other forms of the invention will occur to those skilled in the art in light of the disclosure herein.

### BRIEF DESCRIPTION OF THE DRAWINGS

FIG. 1 is a block diagram of a document indexing a retrieval system according to one embodiment of the invention.

FIG. 2 is a flowchart of an automatic theme generator for use in the embodiment of FIG. 1.

FIG. 3 is a flowchart of an automatic summary generator for use in the embodiment of FIG. 1.

FIG. 4 is a flowchart of document intake, searching, and retrieving in the embodiment of FIG. 1.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

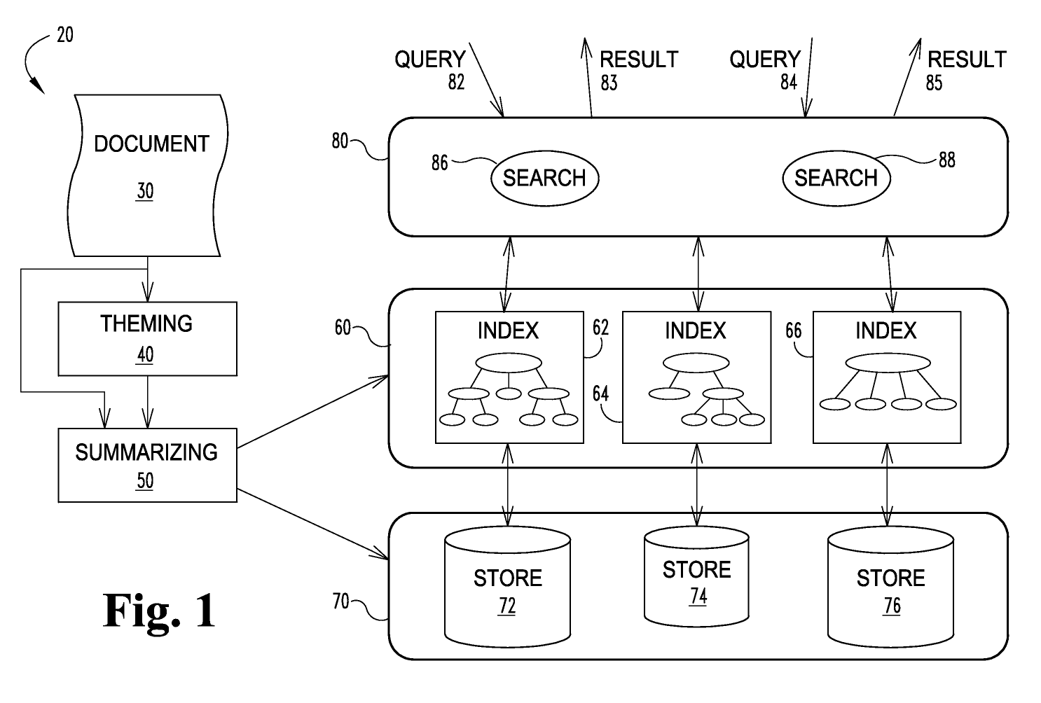

Generally, one form of the present invention is a search and retrieval system for electronic documents shown in FIG. 1. Documents are added to the system through the process shown on the left, then indexed and stored in the components shown on the right. The system receives searches from the top right and returns results responsive to those queries as will be discussed herein.

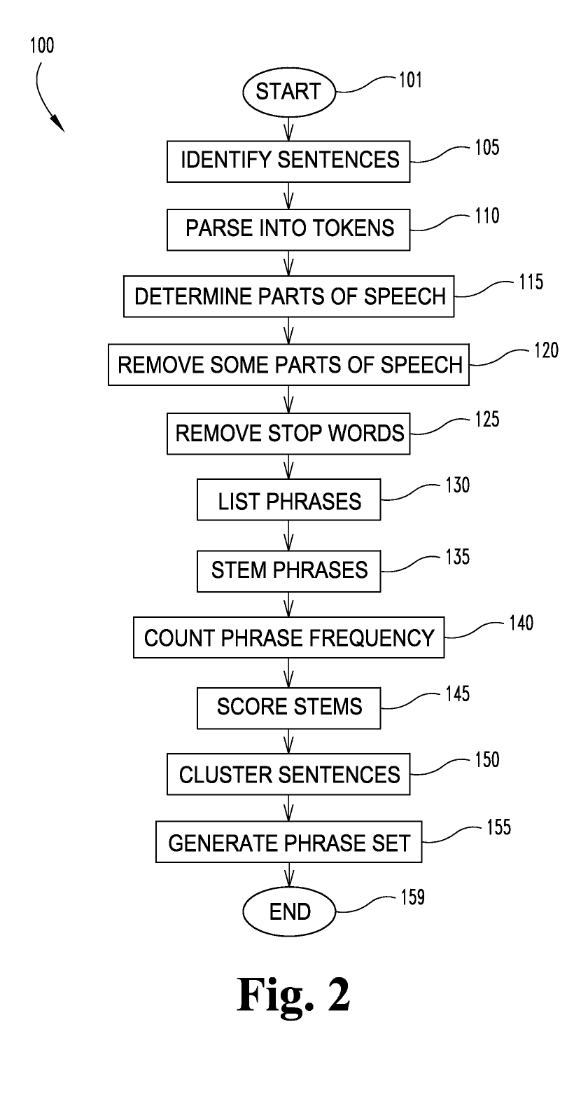

Turning to discuss the embodiment of FIG. 1 in more detail, system 20 accepts new document 30 and determines theme information for document 30 at theming block 40. In this embodiment, theming block 40 scans the text of document 30 and creates a set of phrases or phrase stems that reflect its conceptual theme or themes. A preferred theming process will be discussed in relation to FIG. 2 below.

In this embodiment, the text of document 30 and the theme data generated by theming block 40 provide input to summarizing block 50. Summarizing block 50 generates one or more passages for people to read as an abstract of the full document. Summarizing block 50 associates the theming data from theming block 40 and the document summary from summarizing block 50 with the document data itself and transmits the data package to index unit 60. Index unit 60 determines the one or more document clusters of which document 30 should be a part using methods that will be discussed herein and those variations and alternatives that would occur to one skilled in the art.

Each index in index collection 60 manages an index of one or more documents clustered by content, and is associated with one or more specific data stores within collection 70. In this embodiment, a single index from index collection 60 may be associated with more than one data store in storage collection 70, but each store is associated with only a single index. A store may be a single storage device or a group of storage devices, and may include a portion of a physical device that is also used by another store.

Each index 62, 64, 66 also includes a search engine for determining which clusters match a query better than some threshold, as will be discussed below. Each index 62, 64, 66 also comprises a document retrieval facility that accepts a list of document identifiers and retrieves those documents from their respective stores in collection 70.

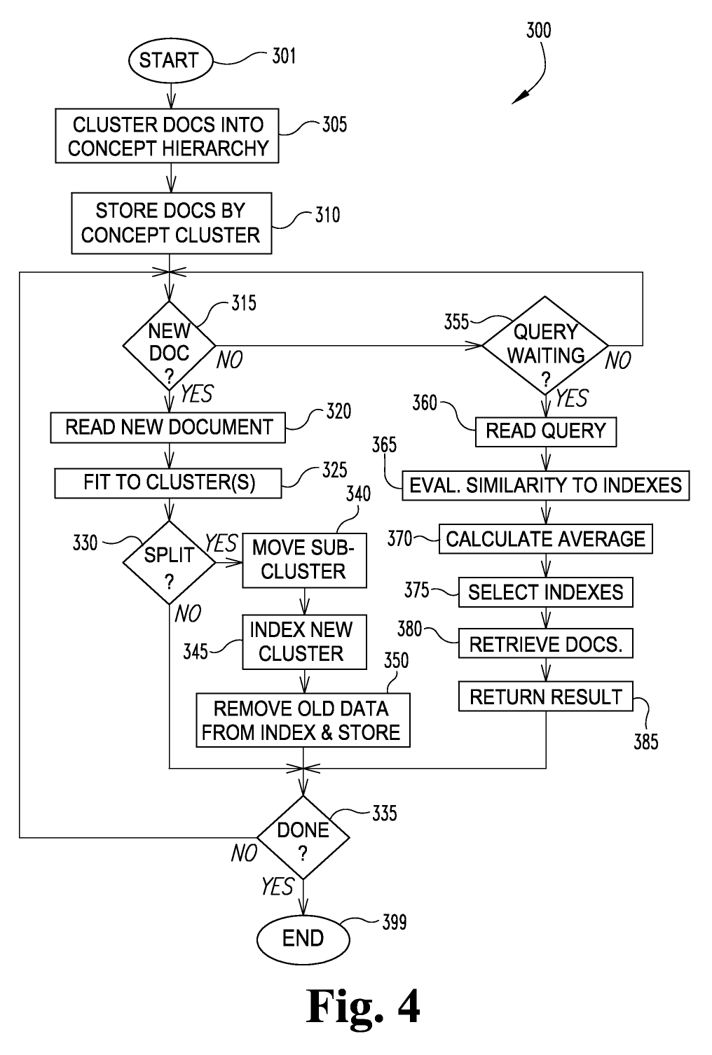

When a query 82, 84 reaches query processing unit 80, search unit 86, 88 parses the query and processes it through index layer 60 to return result 83, 85, respectively. The methods by which this is accomplished will be discussed below in relation to FIG. 4.

Turning to FIG. 2, we examine the process, implemented in software, by which system 20 automatically generates theme information at theming block 40. Process 100 begins at START point 101, and the system identifies the sentences in the document at block 105. The system parses each sentence into tokens at block 110. In some embodiments, tokens are words, while in others, tokens are phonemes, syllables, n-grams of characters, or a selection of words and common phrases from a predetermined list.

In the present embodiment, the system determines the part of speech of each token at block 115. Tokens acting as certain parts of speech are removed at block 120. In some embodiments, articles, conjunctions, and prepositions are removed from the document for the remaining steps of process 100, while in other embodiments prepositions, conjunctions, and interjections are ignored with the remainder of process 100.

“Stop words” are removed from the document at block 125. As will be understood by those skilled in the art, “stop words” are common words that add little value to the processing of searches and document clustering because of their poor value in distinguishing sentences, phrases, and other text units from other such units.

Then, at block 130 the system lists the phrases in document 30 by enumerating the sets of consecutive words from individual words (phrase length l) up to a predetermined maximum number of words per phrase wpp. Each phrase is then “stemmed” at block 135 by truncating each phrase after at most a predetermined number of characters max_char, meanwhile maintaining a map relating each stem to the phrase(s) from which it came. The system counts the frequency of each stem at block 140, then scores the stems at block 145. In some embodiments, the score for each stem is computed as a function of the stem's length, frequency, position (within a paragraph, section, and/or document), or some combination thereof. The stems are sorted based on their score and expanded into their corresponding phrase(s) using the map, and the most frequently appearing phrase for each stem is selected. This selection yields a list of top-scoring phrases.

The sentences in document 30 (as identified at block 105) are clustered at block 150 using a similarity metric that is a function of the number of phrase stems that the sentences have in common, and the scores of those stems. In alternative embodiments, the similarity metric is a function of another combination of parameters that may include, but are not necessarily limited to, the phrase length, sentence length, number of sentences in the cluster, number of sentences in the cluster (or document) that include each stem or phrase, position of each phrase, stem or sentence, or other parameter that would occur to one skilled in the art. At block 155, the final phrase set is generated by selecting all phrases from sentences that are in clusters (from block 150) with at least one other sentence. This final phrase set is the “theme information” for the document 30 that is output from block 40.

Some variations include limiting the “theme information” output to a predetermined maximum number of phrases at block 155, and others process phrases by stemming individual words before the phrase stemming occurs at block 135. Still other embodiments perform multiple steps simultaneously and/or in parallel, such as the listing of block 130, stemming of block 135, and counting of block 140. In some of these embodiments, a pipeline of processors or processes handles each of these steps simultaneously.

The clustering of sentences at block 150 is preferably accomplished using one of the soft clustering techniques known to those skilled in the art. The comparison of phrases and/or sentences (at block 150 and elsewhere), and even the clustering of text entities are implemented in some embodiments using the Lucene engine, which is described and available at http://lucene.apache.org. Other text handling engines may be used with the invention and will occur to those skilled in the art.

Process 100, corresponding roughly to theming block 40 in FIG. 1, ends at END point 159.

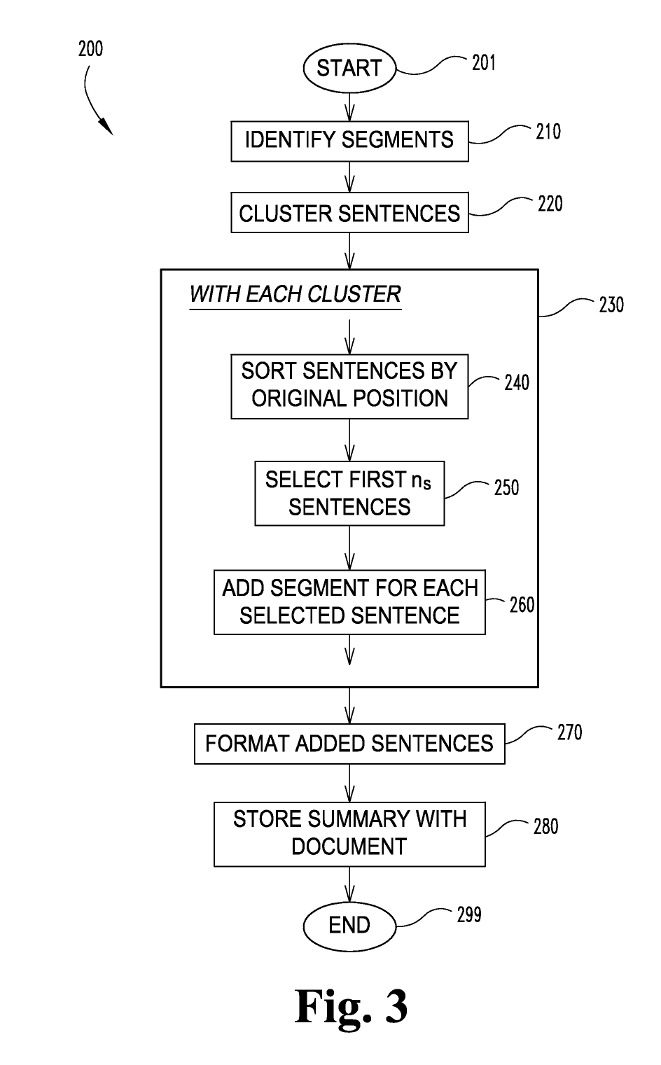

FIG. 3 illustrates process 200, which corresponds roughly to summarizing block 50 of FIG. 1. Process 200 begins at START point 201, and coherent segments of the text are identified at block 210. This is preferably achieved using the algorithm described in Advances in Domain Independent Linear Text Segmentation, by Freddy Y. Y. Choi, published by The North American chapter of the Association for Computational Linguistics (NAACL), Seattle, USA, 2000. The sentences in the document (see block 105 of FIG. 2) are clustered based on the similarity of phrases (see process 100) of each. In alternative embodiments, the sentences themselves are clustered by word similarity, either taking or not taking into account word families and/or synonyms.

Process 200 then iterates over these clusters, applying the steps within block 230 to create a new paragraph for each. At block 240, the sentences in the cluster are sorted by original position, then the first nₛ sentences in the sorted list are selected at block 250. At block 260, the segment (identified at block 210) for each sentence selected at block 250 is added to a paragraph. The system ignores entries that would result in duplicate sentences being included.

The added segments are formatted for display at block 270, and the summary that has been created is stored with the document 30 at block 280. Process 200 ends at END point 299.

FIG. 4 illustrates process 300, by which the system 20 of FIG. 1 proceeds in normal operation, and will now be discussed with continuing reference to elements of FIG. 1. From START point 301, an existing corpus of documents is clustered at block 310 into a hierarchical cluster structure.

The documents in the corpus are stored at block 310 in various stores 72, 74, 76 in storage layer 70 according to the clusters determined for each document at block 305.

The remainder of process 300 will now be described as a polling loop implementation. Those skilled in the art will appreciate that corresponding functionality may be implemented by separate server processes in an event-driven framework, or by other means.

At decision block 315 the system determines whether a new document is available for adding to the index and data repository layers. If so, the system reads the new document at block 320, then determines at block 325 into which conceptual cluster(s) the document best fits. At block 330, process 300 determines whether one or more of those clusters should be divided into separate clusters based on predetermined criteria. For example, if the number of documents assigned a particular conceptual cluster exceeds a predetermined threshold, or if the similarity between documents in the conceptual cluster is less than another threshold, then the documents in that cluster are reevaluated and reclassified into multiple conceptual clusters. Other criteria and timings for the re-clustering triggers used with this invention will occur to those skilled in the art.

If the conceptual cluster is not ready to be split (a negative result at decision block 330), process 300 continues at decision block 335, as discussed below. If it is time to split the cluster (a positive result at decision block 330), process 300 moves the data for the new sub-cluster(s) at block 340 to a new storage device in storage collection 70. A new index for the new cluster is created at block 345. The old copy of the data that was moved at block 340 is removed from its former index and data store at block 350, and process 300 proceeds to decision block 335.

If no document is waiting for import into the system (a negative result at decision block 315), the system determines at decision block 355 whether a query is waiting to be processed. If processing is not complete, process 300 proceeds to decision block 335 to determine whether processing is complete. If processing is not complete, process 300 returns to decision block 315 to determine whether a new document is available for import. If process 300 determines at decision block 335 that processing is complete, then process 300 terminates at END point 399.

If a query signal 82, 84 is waiting for processing (a positive result at decision block 335), then the query is read by search handler 86 or 88 at block 360, and the similarity of the search criteria to each index in collection 60 is evaluated and quantified as a similarity value at block 365. In this embodiment, the average similarity value is calculated at block 370, and indexes having a similarity value greater than that average are selected at block 375. Documents from those indexes are retrieved at block 380, and a result signal 83, 85 is returned at block 385. Process 300 continues at decision block 335 as described above.

One known clustering method that is used in some embodiments of the present invention is known as the “Fuzzy ART” (adaptive resonance theory) method. Assume that a collection of items, each characterized by a vector, is to be grouped into one or more clusters. Select a choice parameter β>0, vigilance parameter ρ (where 0≦ρ≦1), and learning rate λ (where 0≦λ≦1). Then for each input vector I, and set of candidate prototype vectors P, (step 1) find the closest prototype vector PᵢεP that maximizes

$$\frac{‖ \vec{I} ⋀ {\vec{P}}_{i} ‖}{β + ‖ {\vec{P}}_{i} ‖} .$$

Parameter β, therefore, works as a tiebreaker when multiple prototype vectors are subsets of the input pattern I.

The selected prototype Pᵢ then undergoes a “vigilance test” (step 2) that evaluates the similarity between the winning prototype and the current input pattern against the selected vigilance parameter ρ by determining

$$\frac{‖ \vec{I} ⋀ {\vec{P}}_{i} ‖}{‖ \vec{I} ‖} ≻ ρ .$$

If prototype Pᵢ passes the vigilance test, it is adapted to the input pattern I according to step (3), described in the next paragraph. If prototype Pᵢ does not pass the vigilance test, the current prototype is deactivated for the current input pattern I and other prototypes in P undergo the vigilance test until one of the prototypes passes. If no prototype Pᵢ in P passes, a new prototype is created and added to P for the current input pattern I.

If one of the prototypes Pᵢ passes the vigilance test, then the matched prototype is updated (step 3) to move closer to the current input pattern according to \vec{P}ᵢ=λ(\vec{I} [symbol] \vec{P}ᵢ)+(1−λ)\vec{P}ᵢ. As can be observed, selected parameter λ controls the relative weighting between the old prototype value and the input pattern in the revision of the prototype vector. If λ=1, the algorithm is characterized as “fast learning.”

A preferred “soft clustering” variant on Fuzzy ART methods has been developed to improve user profile development and output document clustering in embodiments of the present invention. This variant operates on a collection of documents in three stages: pre-processing, cluster building, and keyword selection.

In the pre-processing stage, stop words are removed from all of the documents in the collection, and a list of the w (remaining) unique words in the collection of documents is created. A document vector is then formed for each document of the frequencies with which each word from the word list appears in that document.

The cluster building stage adapts the Fuzzy ART algorithm to make it a soft clustering algorithm. In particular, instead of selecting a “closest prototype” in step 1, each prototype PᵢεP is considered according to the vigilance test in step 2, and a fuzzy “degree of membership” of I in Pᵢ is assigned based on

$$\frac{‖ \vec{I} ⋀ {\vec{P}}_{i} ‖}{‖ \vec{I} ‖} .$$

Each prototype Pᵢ that passes the vigilance test is then updated as in step 3 above.

It is noted that in various embodiments of this modified approach computational intensity is substantially reduced by avoiding the iterative search for a “best match” in step 1 of Fuzzy ART as described above. In fact, in many embodiments the system can be scaled to cluster more and more documents using only O(n) computational power, providing tremendous advantages (and even enabling otherwise intractable undertakings) versus O(n log n) and higher-order methods known in the art. Further, by removing that choice step from the clustering method, the system ceases to depend on one of the user-selected input parameters (choice parameter β). This streamlines system design by reducing the number of variables over which the designer must optimize parameter selections.

In various alternative embodiments, some or all of the indexes and document databases in collection 60 and 70 are locked during an update and/or a cluster-splitting procedure. In others, a database management system that manages the documents and indexes manages threading, synchronization, and other concurrency issues.

In the embodiment described above, similarity evaluations and document retention are achieved using the standard API of the Lucene engine. In other embodiments, alternative metrics for similarity and systems for document management are used as would occur to one skilled in the art.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for indexing and retrieving information regarding a plurality of documents, comprising:
a plurality of data stores, each having
an index and
a search engine for finding documents in the data store that meet one or more search criteria;
a plurality of document concepts, each associated with exactly one of the data stores;
a clustering engine that,
for each of the plurality of documents:
associates the document with one or more of the concepts; and
adds information about the document to the index of each data store with which the one or more concepts is associated; and
updates organization of the concepts according to one or more predetermined criteria.

2. The system of claim 1, wherein the programming instructions are further executable by the processor to:
accept a new document for adding to the data stores;
determine one or more concepts to which the new document relates;
adding the new document to the one or more concepts;
if one or more predetermined criteria are met, dividing at least one of the one or more concepts into a plurality of concepts, each being assigned to a data store.

3. The system of claim 1, wherein the programming instructions are further executable by the processor to:
receive a search signal;
search the indexes of each data store as a function of the search signal;
return a result signal as a result of the search.

4. The system of claim 3, wherein:
the search signal comprises keywords, and
the selecting is performed as a function of the presence of the keywords in each indexed document.

5. The system of claim 1, wherein the one or more search criteria include applying a threshold for a similarity value that quantifies similarity of an indexed document to one or more provided search terms.

6. The system of claim 1, wherein at least two of the plurality of data stores are physically within the same computer housing.

7. The system of claim 1, wherein at least two of the plurality of data stores are physically within different computer housings.

8. The system of claim 1, wherein the data stores are connected to the clustering engine via a computer network.

9. A method of self-organizing and storing a plurality of electronic documents in a plurality of physical storage partitions, including:
clustering a plurality of electronic documents so that each document is in at least one of a plurality of concept clusters, the plurality of concept clusters forming a hierarchy and including:
a first concept cluster and
a second concept cluster that is not a super-cluster of the first concept cluster;
for each concept cluster in the plurality of concept clusters, storing each document in the concept cluster in one of the one or more physical storage partitions; wherein
all documents in the first concept cluster are stored in a first storage partition;
all documents in the second concept cluster are stored in a second storage partition; and
there is no document that is simultaneously
in the second concept cluster,
stored in the first storage partition, and
not in the first concept cluster.

10. The method of claim 9, further comprising:
receiving a new document;
determining a concept cluster in which the new document fits;
adding information about the document to the physical storage partition in which other documents of the fitting concept cluster is stored; and
if one or more predetermined criteria are met as to the fitting concept cluster, that concept cluster being stored in a particular physical storage partition:
splitting the fitting concept cluster into at least two concept clusters;
storing a one of the at least two concept clusters in the particular physical storage partition in which the fitting concept cluster was stored; and
storing a second of the at least two concept clusters in a different physical storage partition from the one in which the fitting concept cluster was stored.

11. The method of claim 9, further comprising:
automatically searching an index of each concept cluster based on a query signal, the query signal including request data, to identify one or more concept clusters that match the request data;
processing each document in the identified concept clusters.

12. The method of claim 9, further comprising independently indexing the documents stored in each physical storage partition.

13. A method of searching electronic documents, comprising:
receiving a query signal that includes one or more search terms;
responsively to receiving the query signal, searching a plurality of concept indexes, each providing an index to a plurality of electronic documents that relate to a common concept, including:
quantifying the relationship between the one or more search terms and each of the concept indexes as a similarity value; and
selecting the concept indexes having a similarity value indicating a relationship closer than a threshold; and
retrieving references to each of the electronic documents in each of the selected concept indexes.

14. The method of claim 13, wherein the retrieving step includes using the references to the electronic documents to retrieve the documents themselves.

15. The method of claim 14, wherein the retrieving step further includes providing the electronic documents in a response signal.

16. The method of claim 14, wherein the retrieving step further includes providing automatically generated summaries of the electronic documents in a response signal.

17. The method of claim 13, wherein the selecting is done as a function of the average of all similarity values from the quantifying step.

18. The method of claim 13, wherein the selecting includes up to a predetermined number of concept clusters that have the best similarity values.

19. The method of claim 13, wherein the selecting includes up to a predetermined number of concept clusters that have the best similarity values, but does not include any concept cluster that has a similarity value that indicates less than a threshold level of similarity.

20. A system for storing and retrieving electronic documents, including:
a search string layer that receives a search query;
one or more physical data stores; and
a concept index layer that includes a plurality of indexes, each index being associated with one of the physical data stores, and each index containing data that relates to a plurality of electronic documents;
wherein the system
quantifies the closeness of the conceptual relationship between each of the indexes and the search query;
based on the quantification, identifies one or more indexes that best match the search query;
identifies the documents indexed by the one or more identified indexes; and
provides a result signal as a function of the identified documents.

21. The system of claim 20, wherein the result signal includes a list of references to the identified documents.

22. The system of claim 21, wherein the list is sorted by similarity of the identified documents to the search query.

23. The system of claim 20, wherein the system also adds documents by:
determining one or more concepts in which a new document fits;
adding information about the new document to the index for each of the one or more concepts;
storing the new document in the physical data store with which the index for each of the one or more concepts is associated.

24. A system for generating a list of one or more themes from an electronic document, comprising a processor and a memory in communication with the processor, the memory being encoded with programming instructions executable by the processor to:
identify sentences in the document;
parse the sentences into tokens;
list all phrases in the document having no more than a predetermined number of tokens;
count the frequency of the phrases;
stem the phrases to a predetermined length;
score each stem as a function of the stem's length and the frequency of the corresponding phrases in the document;
cluster the sentences based at least in part on the scores of the stems they contain; and
generate a phrase set containing phrases from those sentences that were clustered into a cluster with at least one other sentence.

25. The system of claim 24, wherein tokens are words.

26. The system of claim 24, wherein the counting for a document occurs simultaneously with the listing for that document.

27. The system of claim 24, wherein the stemming for a document occurs before the counting for that document.

28. The system of claim 24, wherein the stemming for a document occurs after the counting for that document.

29. The system of claim 24, wherein the scoring is also a function of the position of the stem.

30. The system of claim 24, wherein the programming instructions are further executable by the processor to:
determine the part of speech of a token; and
remove tokens from further processing if they are determined to be of one or more predetermined parts of speech.

31. The system of claim 24, wherein the programming instructions are further executable by the processor to remove from further processing any token that is on a predetermined list.

32. The system of claim 24, wherein the predetermined length for stemming is measured in number of characters.

33. A system for generating a summary of an electronic document, comprising a processor and a memory in communication with the processor, the memory being encoded with programming instructions executable by the processor to:
identify coherent segments of text in an electronic document, each sentence being part of at least one coherent segment;
cluster sentences in the document based on their content;
for each cluster of sentences, generate a passage by:
sorting the sentences in the cluster based on their position in the original document;
selecting a first number of sentences from the beginning of the sorted list; and
for each of the first number of sentences, adding to the passage the smallest coherent segment of which the sentence is a part.

34. The system of claim 33, wherein the clustering is performed as a function of one or more themes for each sentence.

35. The system of claim 33, wherein the programming instructions are further executable by the processor to present each passage as a paragraph of human-readable text.

36. The system of claim 33, wherein the first number of sentences is two.
